(19) United States
(12) Patent Application Publication
(10) Pub. No.: US 2002/0168031 A1
(43) Pub. Date: Nov. 14, 2002

(54) Method and apparatus for communication in an environment having repetitive noise

(76) Inventors: Sean C. Carroll, Kelowna (CA); Peter J. Offenwanger, Kelowna (CA); Donovan J. Rogall, Kelowna (CA)

Correspondence Address: ANTONY C. EDWARDS, SUITE 800, 1708 DOLPHIN AVENUE, KELOWNA, BC, V1Y 9S4, CA

(21) Appl. No.: 10/143,023

(22) Filed: May 13, 2002

Related U.S. Application Data
(60) Provisional application No. 60/290,406, filed on May 14, 2001.

(51) Int. Cl. H04L 27/14

(52) U.S. Cl. 375/325

(57) ABSTRACT

A method of communication in an environment having repetitive noise where the signal bit rate of the incoming signal is substantially an integer multiple of the half-wave frequency of the alternating current wave form, the method including the steps of: in a receiver, de-modulating an incoming signal containing signal bits by taking digital samples of the incoming signal so as to demodulate the incoming signal into separate x and y channels, the x and y channels approximating respectively, a co-sine and sine wave, summing consecutive groups of the samples from the x and y channels so as to determine corresponding x and y channel points, wherein each group of the consecutive groups contains substantially the same number of the samples, within the receiver, defining at least first and second demi-bits wherein each demi-bit of the first and second demi-bits is of the same length and wherein the first and second demi-bits together, or integer multiples of the first and second demi-bits together, are the same length as one signal bit of the signal bits, using the x and y channel points within the demi-bits to calculate an average phase and an average magnitude over each the demi-bit: so as to produce a first bit channel of the y channel points when averaged over the first demi-bits, and a first channel of the x channel points when averaged over the first demi-bits, and so as to produce a second bit channel of the y channel points when averaged over the second demi-bits, and a second channel of the x channel points when averaged over the second demi-bits, determining the resulting phase and magnitudes of the first demi-bits of the first bit channel and the resulting phase and magnitudes of the second demi-bits of the second bit channel, comparing the magnitudes of the first and second bit channels and choosing the bit channel having the largest overall magnitude as the bit channel from which data is to be read, reading data from the bit channel from which data is to be read by determining phase angles in that bit channel, wherein the phase angles indicate corresponding phase-shift keyed data bits as determined by rejecting phase angles which fall into phase-shift angle fail regions interposed between ranges of acceptable phase-shift angles.

### CROSS REFERENCE TO RELATED APPLICATION

This application claims priority from U.S. Provisional Patent Application No. 60/290,406 filed May 14, 2001 entitled Method of Communication in an Environment Having Repetitive Noise.

### FIELD OF THE INVENTION

This invention relates to the field of communication between two or more transmitter/receivers, or transceivers, in an environment with noise and attenuation, and for example to communication in an environment like that found on or near power lines where noise tends to be repetitive in nature.

### BACKGROUND OF THE INVENTION

FIG. 1 illustrates this. The three units are the transceivers that are trying to communicate. Hindering this communication is that fact that noise is added to the signal and the fact that there can be large amounts of signal attenuation. Attenuation by a factor of 10,000 or more can occur.

In this application reference is made to communication using a method called binary phase shift keying (BPSK), so some background is necessary. However, the present invention is not limited to BPSK as other methods of modulation including quadrature phase shift keying may also benefit.

An example of BPSK is shown in FIGS. 2a-c. FIG. 2a shows the signal to be sent. FIG. 2b shows the modulating waveform. FIG. 2c shows the resulting modulated waveform that is transmitted. As you can see the waveform in FIG. 2c is just the waveform in FIG. 2a multiplied by the waveform in FIG. 2b. This example will be used extensively, but, of course, is not intended to be limiting.

FIG. 2a shows a bit stream of 1,0,1,1,0 if we define a positive one as a “1”. This definition is arbitrary though and the bit stream could be just as easily 0,1,0,0,1. Because of this it is often better not to define the data either way but to use the changes in the signal to define the data. For example if we define a “change” to be a “1 ” and “no-change” to be a “0” the data stream is 1,1,0,1. This use of the changes to encode data is called differential encoding. For the purposes of this discussion we will consider the pattern in FIG. 2a to be five signal bits that use differential encoding to encode the four data bits. That is we have signal bit stream of 1,0,1,1,0 (or 0,1,0,0,1) that encodes a data bit stream of 1,1,0,1.

Although this invention applies to transceivers, it deals with the reception of a signal. Thus,FIG. 3 shows the basic blocks of such a receiver. These consist of a bandpass filter stage (31), a gain stage (32), and optional second filter stage (33), an analog to digital converter stage (34) and a processor stage (35). The first bandpass filter stage helps reject out of band noise. The gain stage amplifies the signal to a level acceptable to the analog to digital converter. The optional second filter stage further filters the signal and is discussed below. The analog to digital stage converts the signal to a digital form that the processor can accept as an input. The processor performs the computations necessary to receive a signal. Note that these stages need not be separate devices but could be included in one integrated circuit.

We will now discuss the reception of a BPSK signal. FIGS. 4a-d illustrate this. FIG. 4a is the incoming signal. FIG. 4b is a sine wave at the carrier frequency and is identical to the modulating waveform shown in FIG. 2b. FIG. 4c is FIG. 4a multiplied by FIG. 4b. FIG. 4d is a low-pass filtered version of FIG. 4c. As you can see the resulting waveform (FIG. 4d) strongly resembles the transmitted bit stream shown in FIG. 2a. So to receive the bit stream we have multiplied the incoming signal with a waveform the same as the modulating waveform and low-pass filtered the result. This is called demodulation.

However, there are some problems. The receiver doesn't know the phase of the signal that is being transmitted. If it demodulates with the wrong phase the signal can be greatly reduced or even disappear. FIGS. 5a-d illustrate this. The demodulating waveform (FIG. 5b) is 90° out of phase with the original modulating waveform. As you can see the resulting waveform (FIG. 5d) has virtually vanished compared to the resulting waveform in FIG. 4d.

The solution to this is to demodulate with two waveforms 90° out of phase with each other (a cosine and a sine wave). Many systems use complex feedback loops (for example a Costas-loop) to force one of these waveforms to be in phase with the incoming signal so that proper demodulation can occur. These feedback techniques are well known and will not be discussed. They are not used in this invention.

As mentioned above, one problem with reception is that the phase of the transmitted signal is not known. Another problem is that the receiver doesn't know when the bit stream is going to start. Another problem is that there can be a great deal of noise added to, and attenuation of, the signal. Another problem is that we don't want two (or more) units trying to communicate at the same time. If the units can initiate communications at any time we need to prevent them from transmitting when another unit is transmitting.

It is consequently an object of the present invention to address these problems.

In the prior art, applicant is aware of U.S. Pat. No. 4,514,697 which issued Apr. 30, 1985 to York for a Coherent Phase Shift Keyed Demodulator With Improved Sampling Apparatus and Method. York teaches a microprocessor-based coherent phase shift keyed demodulator which determines the baseband data information which has been phase modulated onto a carrier by determining the phase of the incoming carrier signal and analyzing by polarity sampling of the carrier zero-crossings of the carrier signal. The demodulator is taught to be synchronized with the carrier for coherent operation, and in particular, that carrier synchronization is accomplished by correlation signals derived from comparisons of the phase angle signal and phase reference signal in a phase detector being summed, compared and processed. What is neither taught nor suggested is the deliberate lack or absence of any attempt to maintain synchronization, during the sampling processing, with the carrier wave while still providing for extraction of the baseband data phase modulated onto the carrier.

### SUMMARY OF THE INVENTION

In summary, the present invention includes a method of communication in an environment having repetitive noise where the signal bit rate of the incoming signal is adapted to be an integer multiple of the half-wave frequency of the alternating current wave form. The method includes the steps of:

(a) in a receiver, de-modulating an incoming signal containing signal bits by taking digital samples of the incoming signal so as to demodulate the incoming signal into separate x and y channels, the x and y channels approximating respectively, a co-sine and sine wave,

(b) summing consecutive groups of the samples from the x and y channels so as to determine corresponding x and y channel points, wherein each group of the consecutive groups contains substantially the same number of the samples,

(c) within the receiver, defining at least first and second demi-bits wherein each demi-bit of the first and second demi-bits is of the same length and wherein the first and second demi-bits together, or integer multiples of the first and second demi-bits together, are the same length as one signal bit of the signal bits,

(d) using the x and y channel points within the demi-bits to calculate an average phase and an average magnitude over each the demi-bit:

(i) so as to produce a first bit channel of the y channel points when averaged over the first demi-bits, and a first channel of the x channel points when averaged over the first demi-bits,

(ii) and so as to produce a second bit channel of the y channel points when averaged over the second demi-bits, and a second channel of the x channel points when averaged over the second demi-bits,

(e) determining the resulting phase and magnitudes of the first demi-bits of the first bit channel and the resulting phase and magnitudes of the second demi-bits of the second bit channel,

(f) comparing the magnitudes of the first and second bit channels and choosing the bit channel having the largest overall magnitude as the bit channel from which data is to be read,

(g) reading data from the bit channel from which data is to be read by determining phase angles in that bit channel, wherein the phase angles indicate corresponding phase-shift keyed data bits as determined by rejecting phase angles which fall into phase-shift angle fail regions interposed between ranges of acceptable phase-shift angles.

A signal processor of the receiver does not, when processing the incoming signal, synchronize to, and track, the alternating current voltage wave form or any part of the incoming signal.

In one embodiment the communication channel is the AC power line itself.

The method may further include the steps of defining a third demi-bit, producing a third bit channel, and rejecting two of the three bit channels leaving the bit channel from which date is to be read.

The method may further include the steps of producing the bit channels by overlapping the demi-bits. The first demi-bit may be denoted by A(n), A(n+1), A(n+2) . . . , the second demi-bit may be denoted by B(n), B(n+1), B(n+2) . . . , and the third demi-bit may be denoted by C(n), C(n+1), C(n+2) . . . , so that the step of producing the bit channels by overlapping the demi-bits includes producing the first bit channel of the form A(n)+B(n), A(n+1)+B(n+1), A(n+2)+B(n+2) . . . , the second bit channel of the form B(n)+C(n), B(n+1) +C(n+1), B(n+2)+C(n+2) . . . , and the third bit channel of the form C(n)+A(n+1), C(n+1)+A(n+2), C(n+2)+A(n+3) . . . .

The method may further include the step of detecting and processing a multi-part preamble in the incoming signal and, once the particular signal pattern is found, choosing a channel, wherein choosing the channel includes the step of comparing the magnitudes of the first and second bit channels and choosing the bit channel having the largest overall magnitude as the bit channel from which data is to be read, for processing another part of the multi-part preamble.

The method may further include the step of preventing a transmission from a transmitter corresponding to the receiver while the receiver is choosing the channel.

Where the preamble contains yet another part, the method may include the further step of the receiver monitoring so as to detect that part of the preamble and upon detection of that part of the preamble switching out of choosing a channel and returning to monitoring so as to detect the afore-mentioned “one part” of the preamble.

The part of the preamble referred to above as “yet another part” may be a first part of the preamble. The part of the preamble first mentioned above (referred to as “one part”) may be a second part of the preamble. The part of the preamble second mentioned above (referred to as “another part”) may be a third part of the preamble. The first, second and third parts of the preamble may be consecutive parts of the preamble. The third part of the preamble may consist substantially of phase changes. The second part of the preamble may be a random pattern.

The present invention also includes an apparatus for communicating in an environment having repetitive noise wherein the signal bit rate of the incoming signal is adapted to be an integer multiple of the half-wave frequency of an alternating current wave form. The apparatus may include:

(a) in a receiver, a demodulator for de-modulating an incoming signal containing signal bits, the demodulator demodulating the incoming signal by taking digital samples of the incoming signal so as to demodulate the incoming signal into separate x and y channels so that the x and y channels approximate respectively, a co-sine and sine wave,

(b) means for summing consecutive groups of the samples from the x and y channels so as to determine corresponding x and y channel points, wherein each group of the consecutive groups contains substantially the same number of the samples,

(c) means within the receiver for defining at least first and second demi-bits wherein each demi-bit of the first and second demi-bits is of the same length and wherein the first and second demi-bits together, or integer multiples of the first and second demi-bits together, are the same length as one signal bit of the signal bits,

(d) means for using the x and y channel points within the demi-bits to calculate an average phase and an average magnitude over each the demi-bit:

(i) so as to produce a first bit channel of the y channel points when averaged over the first demi-bits, and a first channel of the x channel points when averaged over the first demi-bits,

(ii) and so as to produce a second bit channel of the y channel points when averaged over the second demi-bits, and a second channel of the x channel points when averaged over the second demi-bits,

(e) means for determining the resulting phase and magnitudes of the first demi-bits of the first bit channel and the resulting phase and magnitudes of the second demi-bits of the second bit channel,

(f) means for comparing the magnitudes of the first and second bit channels and choosing the bit channel having the largest overall magnitude as the bit channel from which data is to be read, and

(g) means for reading data from the bit channel from which data is to be read by determining phase angles in that bit channel, wherein the phase angles indicate corresponding phase-shift keyed data bits as determined by rejecting phase angles which fall into phase-shift angle fail regions interposed between ranges of acceptable phase-shift angles.

In the apparatus a signal processor of the receiver does not, when processing the incoming signal, synchronize to and track the alternating current voltage wave form or any part of the incoming signal.

The apparatus may include means for defining a third demi-bit, producing a third bit channel, and rejecting two of the three bit channels leaving the bit channel from which date is to be read. The apparatus may also include means for producing the bit channels by overlapping the demi-bits. Thus, where the first demi-bit is denoted by A(n), A(n+1), A(n+2) . . . , the second demi-bit is denoted by B(n), B(n+1), B(n+2) . . . , and the third demi-bit is denoted by C(n), C(n+1), C(n+2) . . . , the apparatus may include means for producing the first bit channel of the form A(n)+B(n), A(n+1)+B(n+1), A(n+2)+B(n+2) . . . , the second bit channel of the form B(n)+C(n), B(n+1)+C(n+1), B(n+2)+C(n+2) . . . , and the third bit channel of the form C(n)+A(n+1), C(n+1)+A(n+2), C(n+2)+A(n+3) . . .

The apparatus may further include means for detecting and processing a multi-part preaMble in the incoming signal and, once the particular signal pattern is found, switching the receiver into choosing a channel, for processing another part of the multi-part preamble.

The apparatus may also further include comprising means for preventing a transmission from a transmitter corresponding to the receiver while the receiver is choosing a channel.

When the preamble contains yet another part, the apparatus may also include means for monitoring so as to detect the yet another part of the preamble and upon detection of the yet another part of the preamble switching out of choosing a channel and returning to monitoring so as to detect the one part of the preamble.

### BRIEF DESCRIPTION OF THE DRAWINGS

FIG. 1 is a block diagram illustrating three transceivers communicating in a noisy environment.

FIGS. 2a-2c illustrate an example of binary phase-shift keying wherein FIG. 2a illustrates the signal to be sent, FIG. 2b illustrates the modulating waveform, and FIG. 2c illustrates the resulting modulated waveform.

FIG. 3 is a block diagrammatic view of a prior art receiver.

FIGS. 4a-4d illustrate the reception of a BPSK signal wherein FIG. 4a is the incoming signal, FIG. 4b is a sine wave at the carrier frequency, FIG. 4c is the signal of FIG. 4a multiplied by the modulating waveform of FIG. 4b, and FIG. 4d is the waveform of FIG. 4c low-pass filtered.

FIGS. 5a-5d illustrate demodulating a transmitted signal using the wrong phase wherein FIG. 5a is the transmitted signal, FIG. 5b is 90 degrees out of phase with the original modulating waveform, FIG. 5c is the resulting waveform and FIG. 5d is the resulting waveform once filtered.

FIGS. 6a-6e illustrate demodulating using a co-sine and a sine wave by sampling the signal with an analog to digital converter wherein FIG. 6a is a co-sine wave, FIG. 6b is a sine wave, FIG. 6c shows when samples are taken, FIG. 6d illustrates the x channel and FIG. 6e illustrates the y channel.

FIG. 7 illustrates the use of channel points to determine the phase and magnitude of the incoming signal.

FIGS. 8a-8i illustrate an example of BPSK reception wherein FIG. 8a is an example waveform, FIGS. 8b and 8c are, respectively, the x and y samples of the waveform of FIG. 8a, FIGS. 8d and 8e are, respectively, the x and y channel points corresponding to the samples of FIGS. 8b and 8c, FIG. 8f is the sum of the x channel points summed over each bit, FIG. 8g is the sum of the y channel points summed over each bit, FIG. 8h is the resulting phase of each bit and FIG. 8i is the resulting magnitude of each bit.

FIGS. 9a-9e illustrate the addition of noise to the wave form of FIG. 8a wherein FIG. 9a is the incoming waveform, FIG. 9b is the noise, FIG. 9c is the result of adding the noise of FIG. 9b to the signal of FIG. 9a, FIG. 9d illustrates the resulting average phase calculated for each bit, and FIG. 9e illustrates the resulting average magnitude for each bit.

FIGS. 10a and 10b illustrate an example graphing the bits of FIGS. 8h and 9d respectively.

FIG. 11a illustrates an inferior method of determining whether a phase change has occurred as compared to FIG. 11b which illustrates the use of fail regions interposed between phase change detection regions.

FIGS. 12a-12f illustrate breaking the incoming signal into bit channels wherein FIG. 12a is an incoming signal, FIG. 12b is the signal of FIG. 12a after bandpass filtering, FIG. 12c illustrates bit channel A, FIG. 12d illustrates bit channel B, FIG. 12e illustrates the broken-up signal that falls into the bits of bit channel A, and FIG. 12f illustrates the broken-up signal that falls into the bits of bit channel B.

FIGS. 13a-13h illustrate the results of processing channels A and B separately to calculate phase and magnitude over a demi-bit wherein FIG. 13a illustrates the y channel points averaged over the individual demi-bits of bit channel A, FIG. 13b illustrates the x channel points averaged over the individual demi-bits of bit channel A, FIGS. 13c and 13d illustrate respectively the resulting phase and magnitudes of the demi-bits of bit channel A, FIG. 13e illustrates the y channel points averaged over the individual demi-bits of bit channel B, FIG. 13f illustrates the x channel points averaged over the individual demi-bits of bit channel B, and FIGS. 13g and 13h illustrate respectively the resulting phase and magnitudes of the demi-bits of bit channel B.

FIG. 14a illustrates the use of bit channels A and B, FIG. 14b illustrates the use of three bit channels, namely, channels A B and C, and FIG. 14c illustrates the use of three overlapping bit channels.

FIGS. 15a-15c illustrate a form of preamble according to the present invention wherein FIG. 15a illustrates the data bits of the preamble, FIG. 15b illustrates phase changes of the signal bits corresponding to the data bits of FIG. 15a, and FIG. 15c illustrates the preamble in the form of an incoming signal after bandpass filtering.

FIGS. 16a-16c illustrate the repetitive nature of noise on a power line wherein FIG. 16a shows a 60 Hz waveform for 120 Volt AC power, FIG. 16b illustrates the waveform of FIG. 16a high-pass filtered, and FIG. 16c illustrates the waveform after bandpass filtering.

FIGS. 17a-17f illustrate rejecting noise bursts from the AC waveform wherein FIG. 17a illustrates the noise on the power line, FIG. 17b illustrates Part 3 of the preamble, FIG. 17c illustrates the combination of the waveforms of FIG. 17a and FIG. 17b, FIG. 17d illustrates the corresponding bit channel A, FIG. 17e illustrates the corresponding bit channel B and FIG. 17f illustrates the waveform of FIG. 17e after nonlinear gain according to the present invention.

FIGS. 18a-18e illustrates the low-pass filtered rectified signal lagging the signal using prior art automatic gain control.

FIGS. 19a-19d illustrates the method of using a large gain and clipping the signal in FIGS. 19a-19b, the use of logarithmic gain in FIG. 19c, and the output of a nonlinear amplifier according to the present invention in FIG. 19d.

FIG. 20 illustrates a non-linear amplifier according to the present invention so as to produce the output of FIG. 19d.

FIG. 21 illustrates the phase-shift detect regions and the interposed fail regions as may be employed according to the method of the present invention in Quadrature Phase-Shift Keying modulation.

FIG. 22 illustrates a form of bandpass filter with a switch added.

FIGS. 23a-23d illustrate an improved method according to the present invention and using a zero reference, wherein FIG. 23a is a noisy signal similar to that of FIG. 19a wherein the signal is the higher frequency component and the noise is the lower frequency component, FIG. 23b illustrates the result of using a zero reference method, FIG. 23c illustrates an improved method according to the present invention, and FIG. 23d illustrates the same method according to the present invention applied to a signal not containing the lower frequency noise.

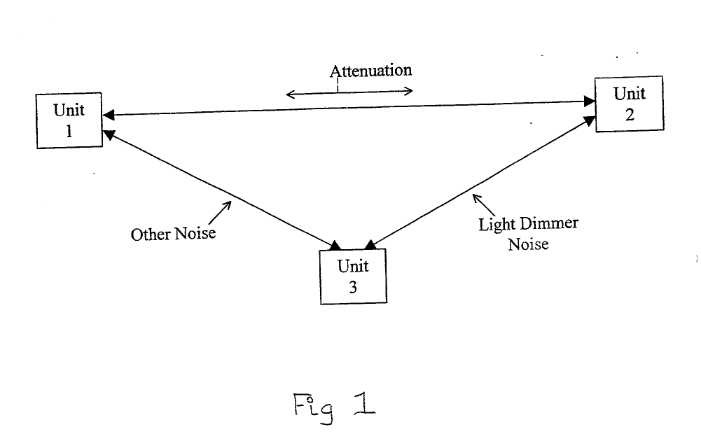

### DETAILED DESCRIPTION OF EMBODIMENTS OF THE INVENTION

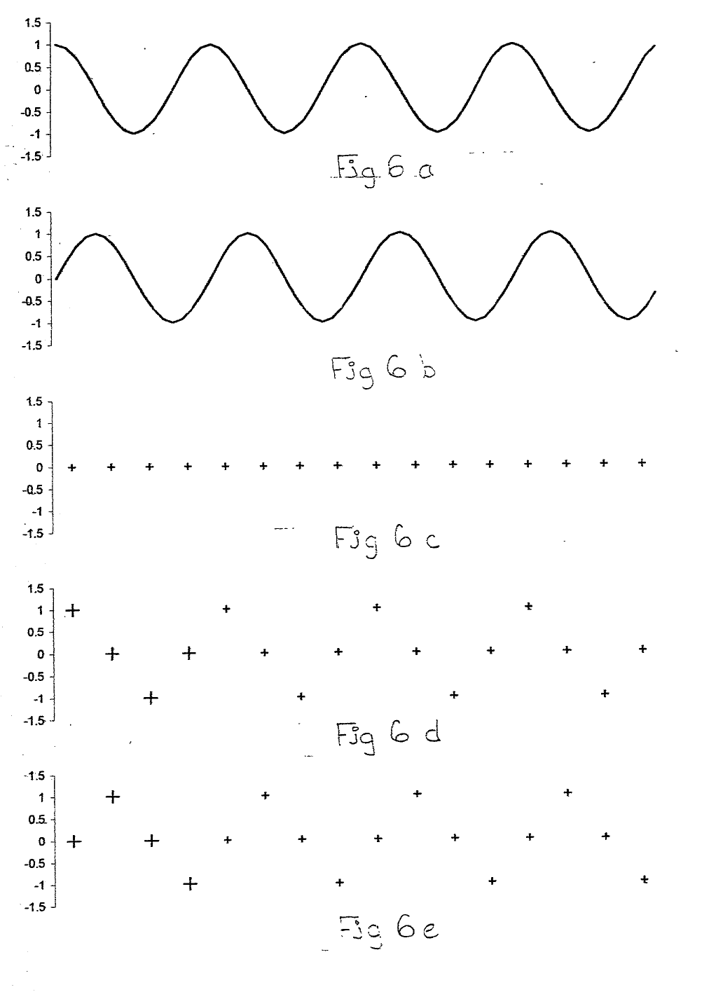

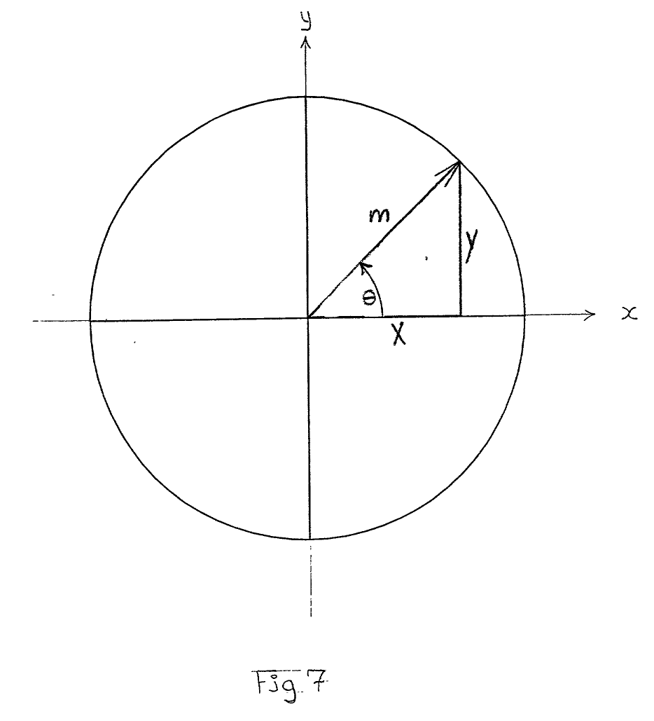

The first problem mentioned above was that the receiver doesn't know the phase of the incoming signal. This invention uses the standard technique of demodulating with a cosine and a sine wave. However, it does this by sampling the signal with an analog to digital converter and inverting some of the samples rather than performing true multiplications. FIGS. 6a-e illustrate this.

FIG. 6a is a cosine wave. FIG. 6b is a sine wave. FIG. 6c shows when samples are taken. FIG. 6d shows what is referred to as the “x channel”. It is generated by taking the first sample, ignoring the second sample, taking and inverting the third sample, and ignoring the forth sample. As you can see in FIG. 6d this approximates multiplying the samples by the cosine wave of FIG. 6a. FIG. 6e shows the sampling of what is referred to as the “y channel”. It is generated by ignoring the first sample, talking the second sample, ignoring the third sample, and taking and inverting the forth sample. It approximates multiplying by the sine wave of FIG. 6b.

It should be noted that other types of sampling can accomplish the same thing.

For example doing the above but using every third sample point. The important thing is that sampling is done in a way that can be used to determine the phase and magnitude of “bit channels” of the incoming signal as better described hereinbelow.

Some definitions are required before continuing. We are going to sum samples together and call them a “channel point”. For example the first four samples of FIG. 6d could be summed together. We will call that an “x channel point”. The first four samples of FIG. 6e could be summed together and be called a “y channel point”. The use of four points summed together to make a channel point is used by way of example, as a channel point may be made using eight points, twelve points, etc. Again what is important is that these channel points can be used to determine the phase and magnitude of bit channels of the incoming signal. FIG. 7 illustrates this.

The phase of the signal, θ, can be found using the formula:

θ=Arctan(y/x)

where “x” is an x channel point described above and “y” is an y channel point. In practice this formula is not computed and some approximation or lookup table is used. The magnitude of the signal, m, can be found using the formula:

m=(x*x+y*y)^{½}

Again some approximation of this is generally used.

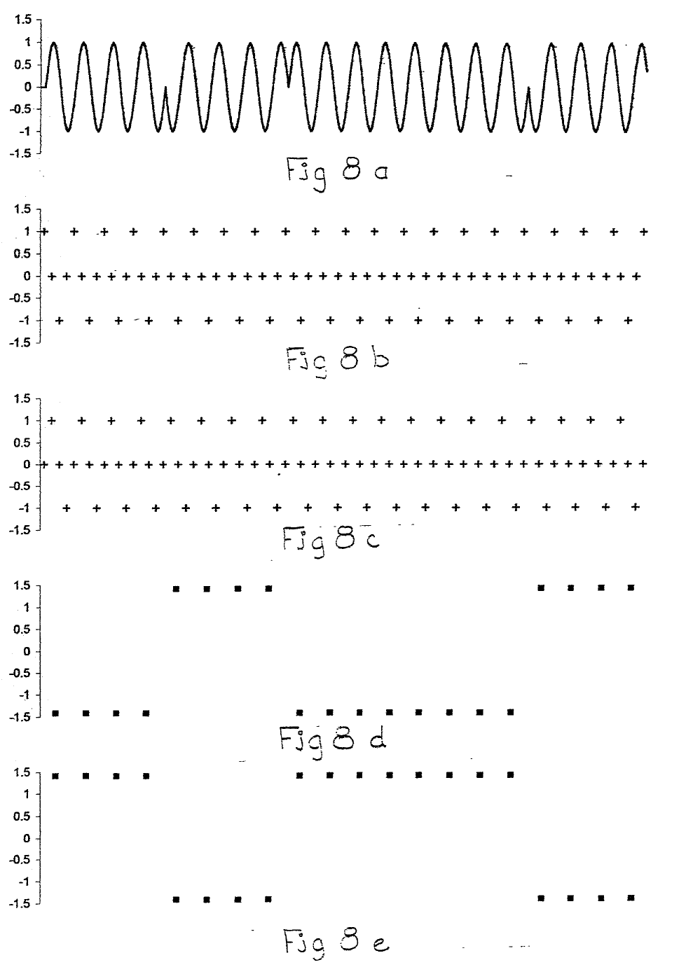

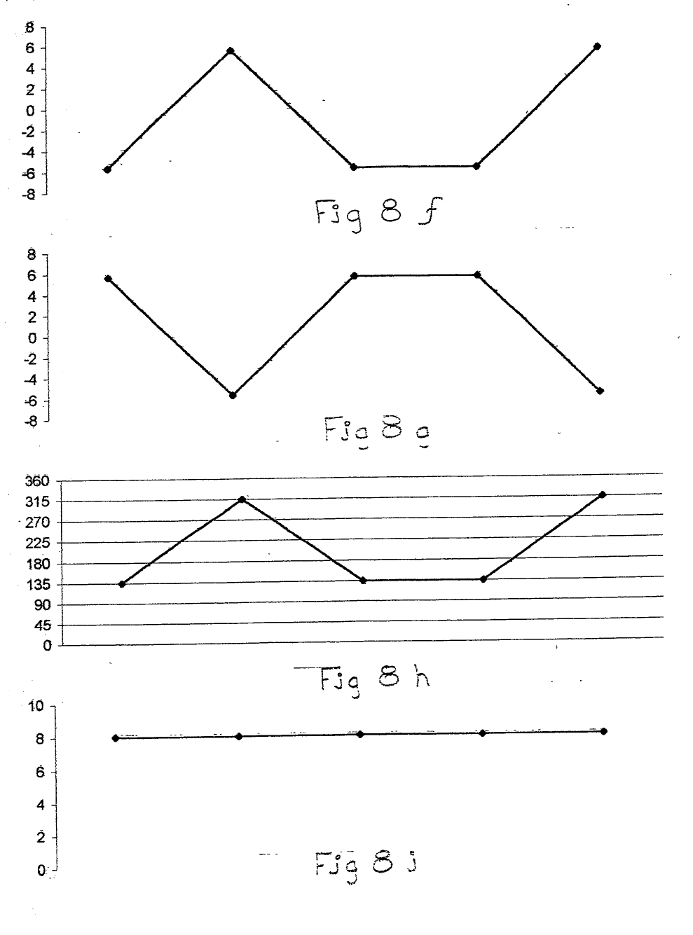

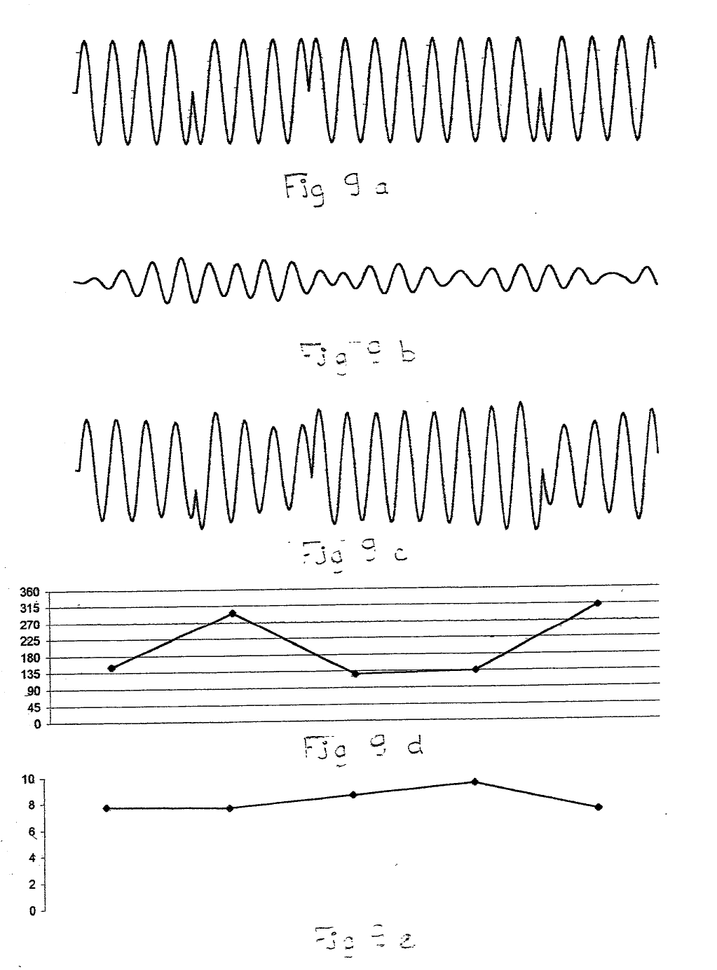

An example of BPSK reception using the above technique is shown in FIGS. 8a-i.

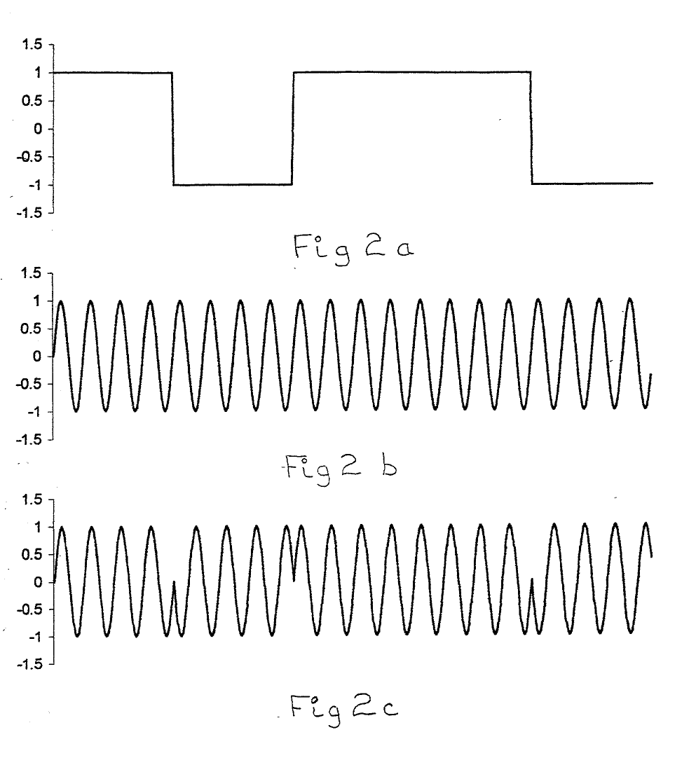

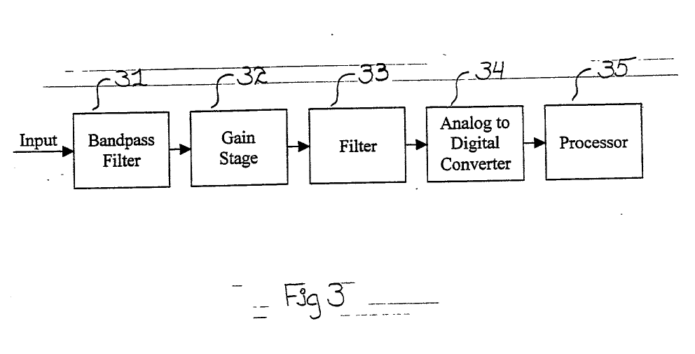

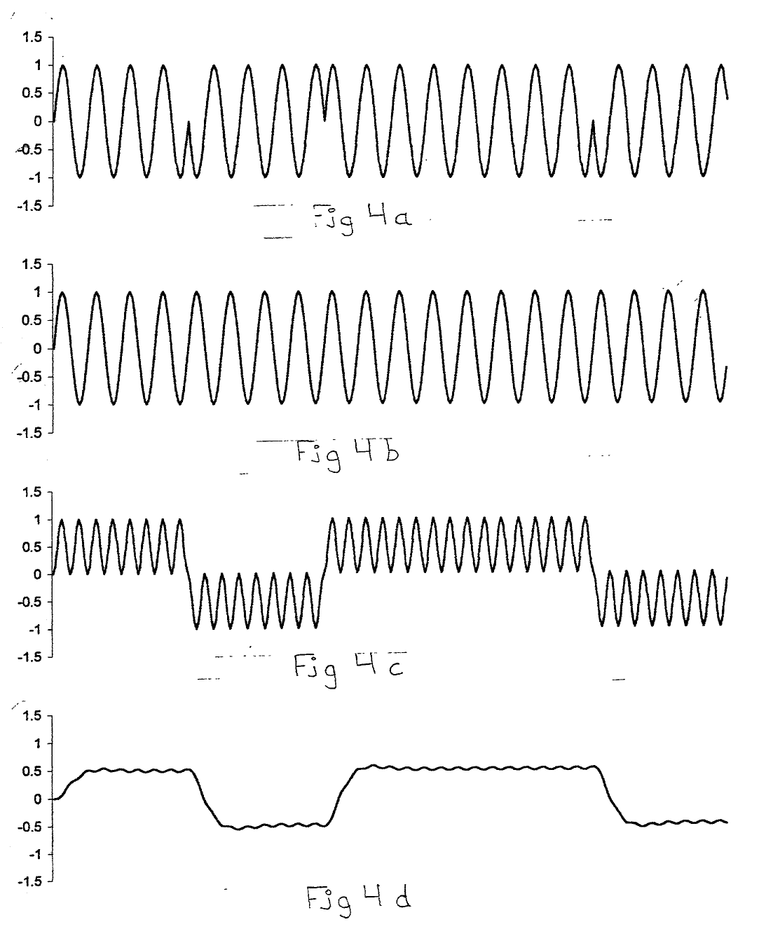

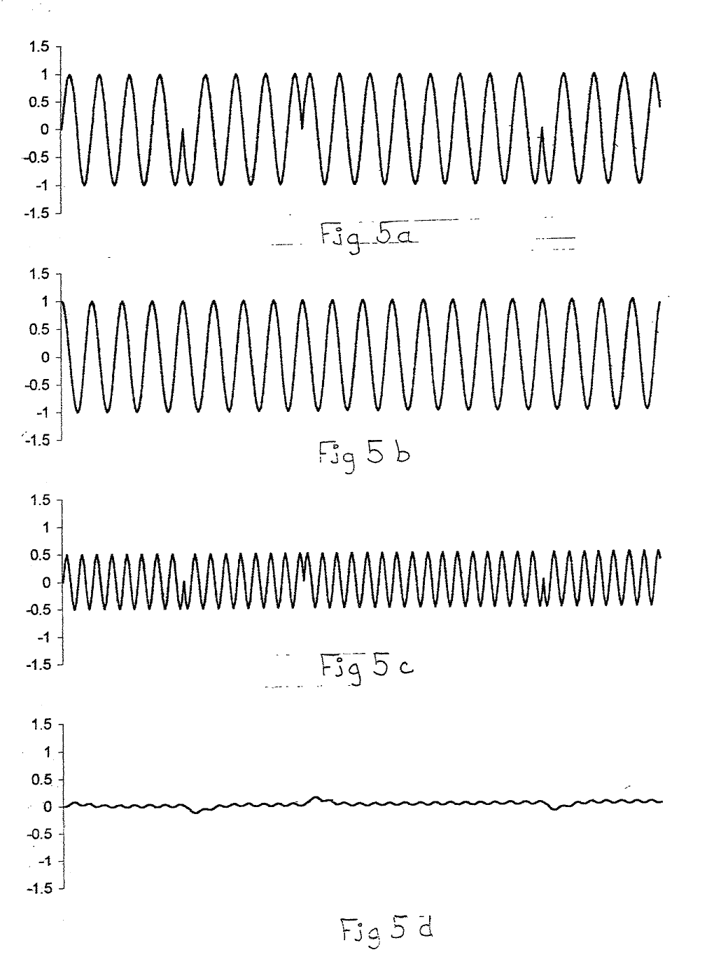

FIG. 8a is our familiar example waveform. FIGS. 8b and 8c are the x and y samples of this waveform. FIGS. 8d and 8e are our x and y channel points found by summing the x and y samples in groups of four. FIG. 8f is the sum of our x channel points summed over each bit. (Refer to FIG. 2a for the signal bit stream). FIG. 8g is the sum of our y channel points summed over each bit. FIG. 8h is the resulting phase of each bit calculated by using the sums of the x and y channel point. FIG. 8i is the magnitude of each bit calculated by using the sums of the x and y channel points. Note that this is different than before when we used just one x channel point and one y channel point to calculate phase and magnitude. The summing of the channel points over each bit results in an average phase and average magnitude being calculated for each bit.

We will now consider the addition of noise to our signal. FIGS. 9a-e illustrate this. FIG. 9a is our signal, FIG. 9b is the noise that is added and FIG. 9c is the result of adding the noise to our signal. FIG. 9d shows the resulting average phase calculated for each bit. FIG. 9e shows the resulting average magnitude for each bit. As you can see the noise has altered the average phase of the received bits.

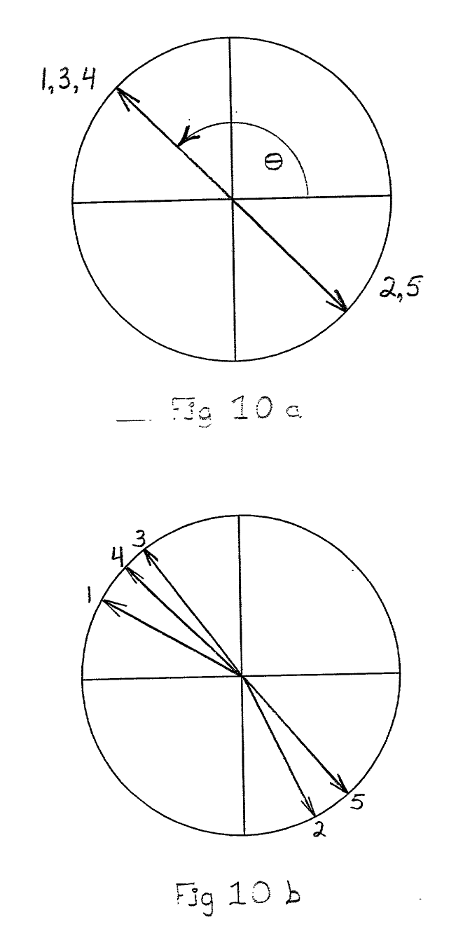

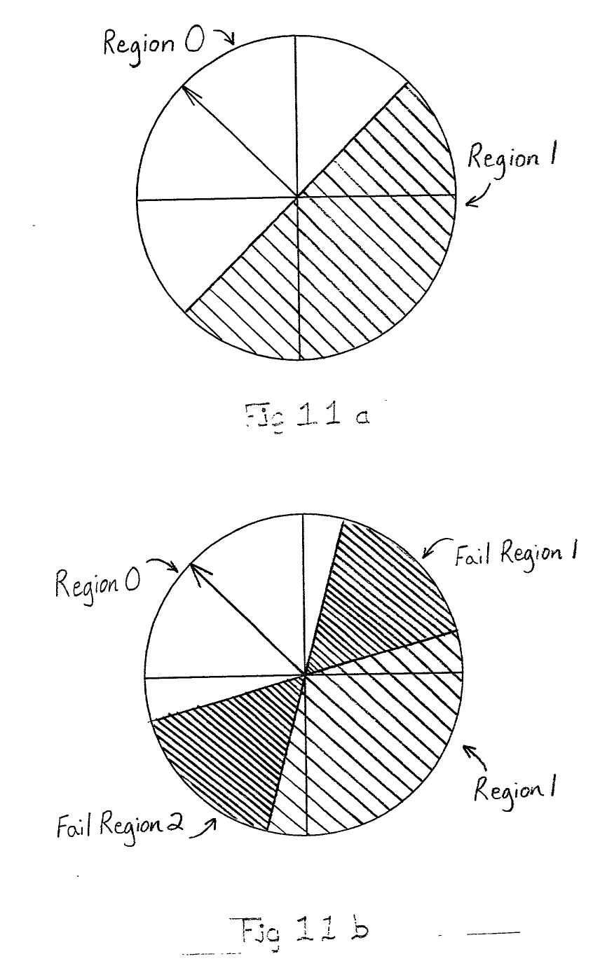

By way of background, one way to graph phase is shown in FIGS. 10a and b. FIG. 10a shows the phase of the bits in FIG. 8h. The numbers indicate the number of the signal bit in the bit stream. As you can see the phases of signal bits 1, 3, and 4 overlap while the phases of signal bits 2 and 5 overlap 180° away. The actual values of the phases are unimportant. What is important is that they either align or are 180° out of phase. FIG. 10b shows the phase of the signal bits in FIG. 9d. As you can see the noise has caused some phase shifting and the signal bits no longer align.

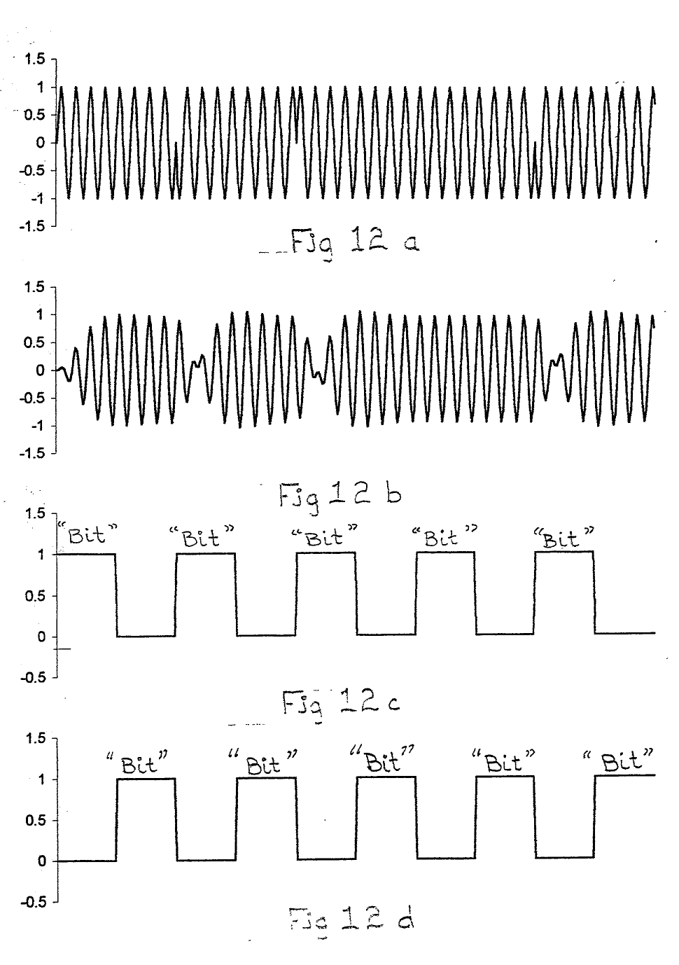

We are using differential encoding where the phase changes encode the data bits in the bit stream, a phase change being defined as a “1 ” and no change being defined as a “0”. In FIG. 10b the phase between signal bits 1 and 2 changes by 146°. This is much closer to 180° than 0° so we would assume that a phase change has occurred. But what if the change was close to 90°? Do we say that if it's greater than 90° there has been a phase change and if it's less than 90° there is no phase change? This is shown in FIG. 11a where region “0” is the region of no phase change and region “1” is the region of a phase change. These regions are centered on the last signal bit. If the phase of the next signal bit falls into region 0 we say that no phase change has occurred, if it falls into region 1 we say a phase change has occurred. We could do this but it seems illogical to accept as data something that has been so corrupted by noise.

A better way is to use four regions shown in FIG. 11b. In this figure we have the “no change” region center on the last bit and the “change” region centered 180° away. In this figure they are 120° wide. Between them they define also two regions where we say the signal has failed. In this figure the fail regions are each 60° wide. If the phase of the bit after the bit shown falls into a fail region we say that the signal has failed. This helps reject marginal data but has an important statistical use as well.

We do not use thresholding, as an example and therefore if there is no signal present then the receiver will be just “listening” to random noise. The receiver does not know this however and is trying to extract a signal. We may start a signal with a preamble to let the receiver know that a signal has occurred. This preamble is a pattern of data bits at the start of the signal that the receiver looks for to “know” that a signal is being received. By way of example, the pattern may be 1,0,1,0,1,0,1,0 or “change”, “no change”, “change”, “no change”. Again we are assuming that no real signal is present and the receiver is just listening to random noise. If signal bit 1 is as shown in FIG. 11a the chance that signal bit 2's phase falls in region 1 (making a “change”) is 50%, the chance that signal bit 3's phase falls into signal bit 2's region 0 (making a “no change”) is 50%, etc. The odds that the receiver will see the pattern 1,0,1,0,1,0,1,0 due to random noise is therefore (½)ô8 or 1 in 256.

We will now calculate the odds that random noise will cause the receiver to think it's receiving a signal if we use the scheme shown in FIG. 11b. Here the chance that signal bit 2's phase falls into region 1 is ⅓, the chance that signal bit 3's phase falls into bit 2's region 0 is 1/3, etc. The odds that the receiver will see the pattern 1,0,1,0,1,0,1,0 is therefore (⅓)Ô8 or 1 in 6561. This is over 25 times larger than the odds would be if we had no fail regions. The fail regions not only reject marginal signals, they also help greatly to reject random noise from being considered a signal.

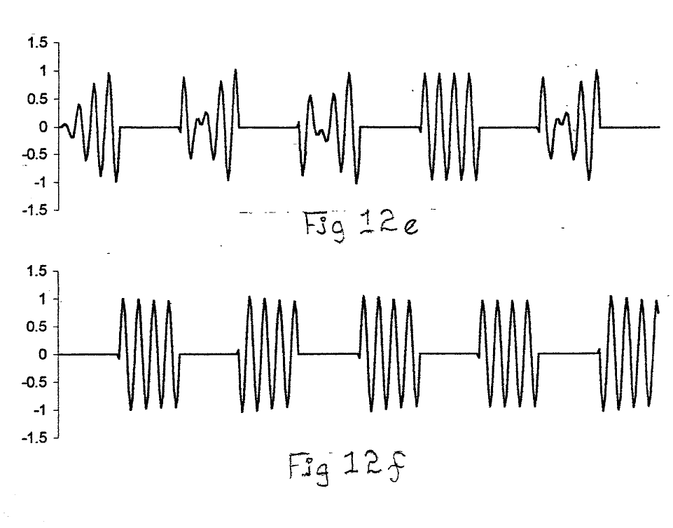

So far, we have assumed that we know when a signal bit starts. In FIGS. 8 and 9 we showed the average phase and magnitude of the signal bits. To get these we had to average the x and y channel points over a signal bit. To do this we need to know when a signal bit starts. It is actually easier and more effective not to try and find the start of a signal bit but to break the incoming signal into “bit channels”. FIGS. 12a-f illustrate this.

FIG. 12a shows our familiar signal. FIG. 12b shows the signal after bandpass filtering. This bandpass filter was shown in FIG. 3 and helps reject out of band noise. FIG. 12c shows what we will call “bit channel A”. FIG. 12d shows what we will call “bit channel B”. FIG. 12e shows the signal that falls into the labeled “bit's” of bit channel A. FIG. 12f shows the signal that falls into the labeled “bit's” of bit channel B. Because these channel “bit's” are one half the length of signal bit we will call them demi-bits. Note that these demi-bits are not aligned with the signal bits of FIG. 12b. However, two demi-bits together are the same length as a signal bit, so while they are not aligned with the signal bits they do not substantially drift with respect to them during the reception of the signal.

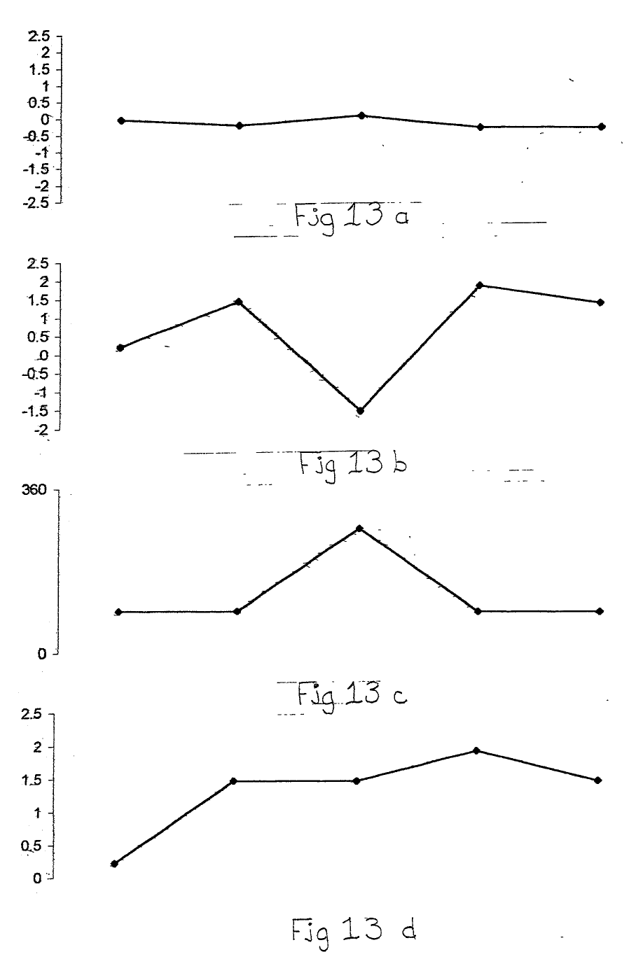

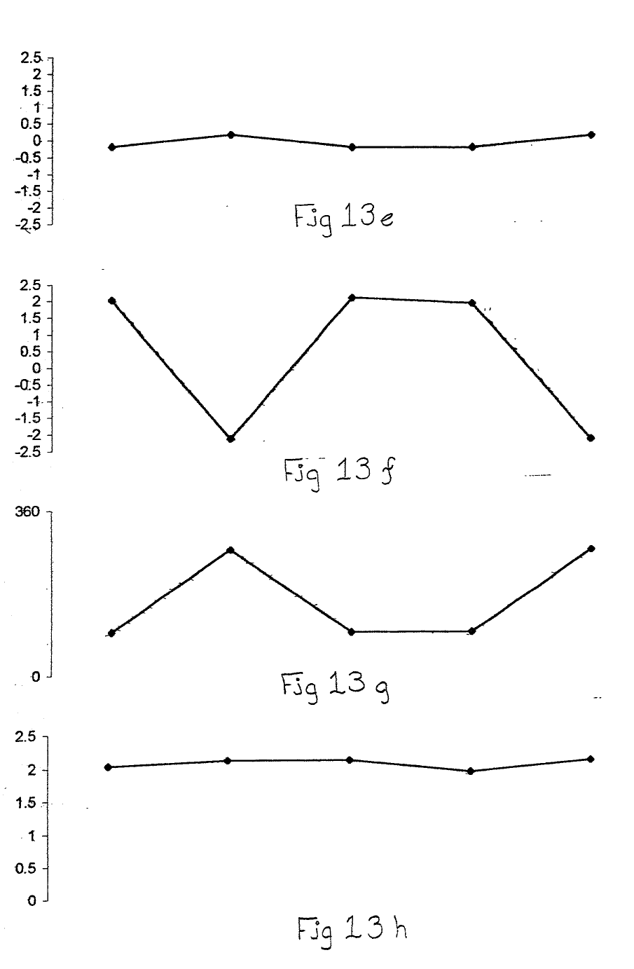

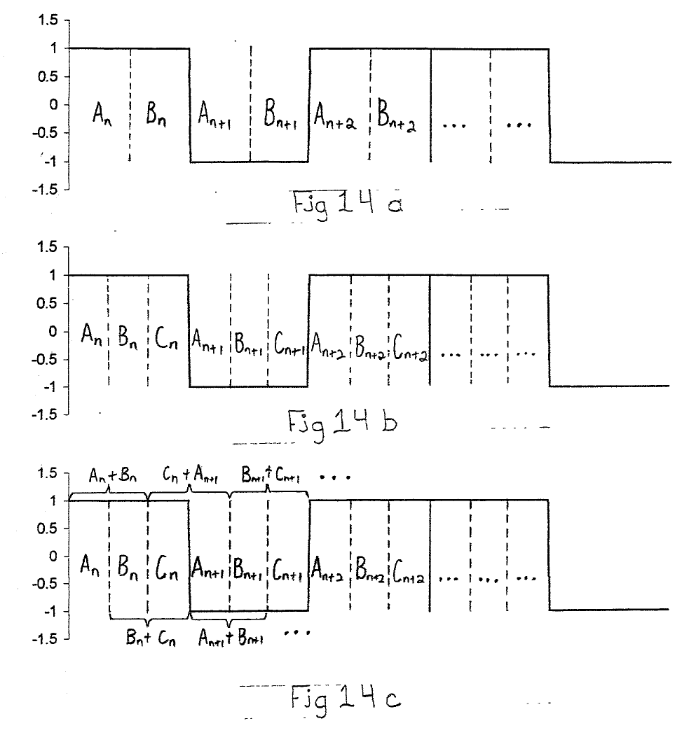

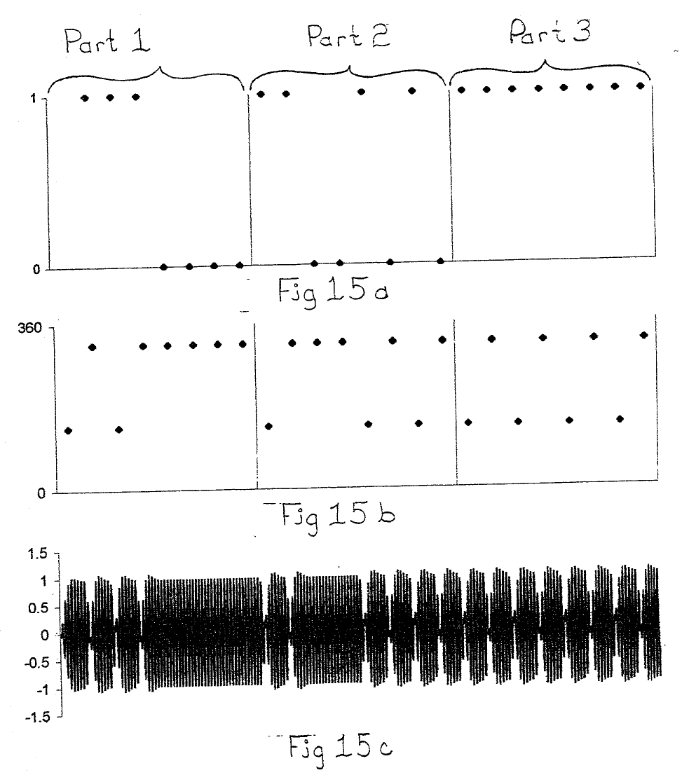

We will now show the results of processing each of these channels separately. We do this processing as before by taking our x and y channel points and calculating phase and magnitude but now we average over a demi-bit not over a signal bit. This is simple because the bit channels are generated inside the receiver. It knows when a demi-bit starts or ends. FIGS. 13a-h illustrate this.

FIG. 13a shows the y channel points averaged over the individual demi-bits of bit channel A. FIG. 13b shows x channel points averaged over the individual demi-bits of bit channel A. FIGS. 13c and 13d show the resulting phase and magnitudes of the demi-bits of bit channel A.

FIG. 13e shows the y channel points averaged over the individual demi-bits of bit channel B. FIG. 13f shows x channel points averaged over the individual demi-bits of bit channel B. FIGS. 13g and 13h show the resulting phase and magnitudes of the demi-bits of bit channel B.

Comparing FIG. 13c to FIG. 8h we see that bit channel A did not receive the correct phase changes. If the receiver had been looking for a preamble that was 1,1,0,1 (that is “change”, “change”, “no change”, “change”) it would have not found it even though this is what was transmitted.

Comparing FIG. 13g to FIG. 8h we see that bit channel B did receive the correct pattern.

If we assume that this pattern was our preamble then bit channel B would have found the correct preamble. The receiver would then assume that the following signal was data.

It would use bit channel B to receive this data and disregard bit channel A. Note that it does not need to find the actual start or end of the signal bits to do this.

If we assume that both channels had received the preamble, we still want the receiver to pick one channel and disregard the other. The method used to pick a channel in this case is to look at the overall magnitude of the bit channels during the preamble and to pick the channel with the largest overall magnitude. Comparing FIG. 13d to FIG. 13h we see that bit channel B had a larger overall magnitude. This is because bit channel B's demi-bits were more centered on the signal bits while bit channel A's demi-bits spanned the changes between signal bits. If both channels had received the correct preamble channel B would still have been chosen.

In the above example we had only two bit channels. This need not be the case. FIGS. 14a-c illustrate this. In FIG. 14a we have two channels A and B as described above. In FIG. 14b we have three channels, channel A, channel B, and channel C. If we were using three channels we would do the calculations the same as in FIG. 13 but we would reject two channels after detecting a preamble. In FIG. 14c we also have three channels but in this case they overlap. The first channel is A(n)+B(n), the second channel is B(n)+C(n), and the third channel is C(n)+A(n+1). Many other channels can be envisioned. The important thing is that the length, that is duration, of such “demi-bits” or bit channels is such that they do not substantially drift with respect to the signal bits.

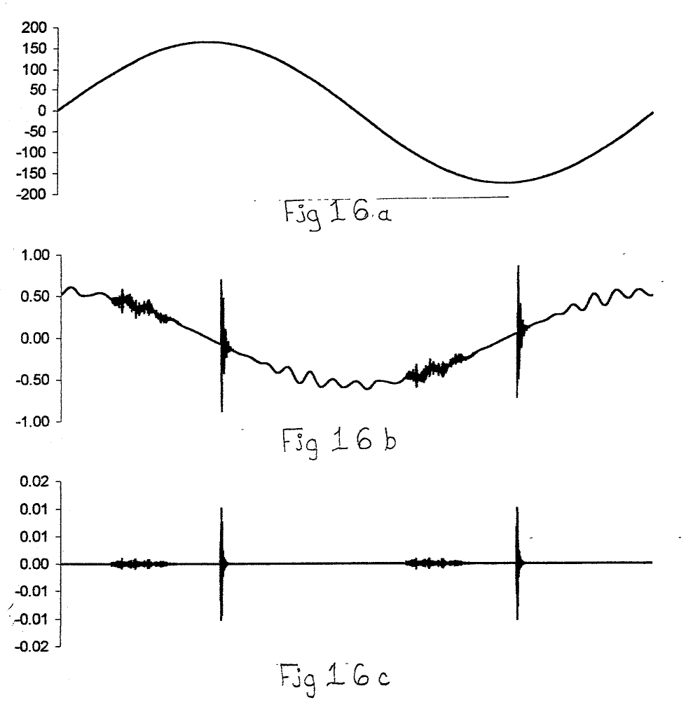

As mentioned above we are using a preamble to let the receiver know when it has detected a signal. I will now discuss a particular form of preamble that has great utility in a noisy environment. This is illustrated in FIGS. 15a-c.

As shown the preamble has three parts. FIG. 15a shows the data bits of the preamble. FIG. 15b shows phase changes of the signal bits that would generate these data bits. FIG. 15c shows the preamble in the form of an incoming signal after bandpass filtering. The data bit sequence in this preamble is by way of example only. We'll ignore part 1 of the preamble for the moment and assume that the receiver uses two bit channels. We'll also assume that we have fail regions as shown in FIG. 11b.

When the receiver is not reading data or trying to pick a bit channel it constantly looks for the pattern of Part 2 of the preamble. Once it has found the pattern of Part 2 it starts looking for the pattern of Part 3. It is in Part 3 that the receiver chooses which bit channel to use and which bit channel to discard. We will call this “channel choose” mode. It is best therefore to have Part 3 consist mostly of phase changes. Referring back to FIGS. 12a-f, channel B was chosen because it centered itself on the bits. Channel A was rejected because it spanned the changes in the bits. So having Part 3 consist mostly of phase changes helps in choosing a channel that is best centered on the bits.

An important purpose of Part 2 of the preamble is to prevent the receiver from transmitting when another unit is transmitting. Once it sees a pattern like Part 2 the receiver assumes a signal is being received and will not allow the unit to transmit for a period of time. This prevents units from transmitting on top of each other. It is best if Part 2 is random in nature.

As mentioned above, an important purpose of Part 3 is to choose a bit channel, while an important purpose of Part 2 is to keep units from talking on top of each other. However, both Parts 2 and 3 together have another purpose: to keep the receiver from assuming random noise is a signal. As mentioned above we are assuming that we have fail regions that make the odds of a random bit fitting a pattern ⅓. Parts 2 and 3 together are 16 bits long. So the odds in this case of random noise fitting the pattern of Part 2 and Part 3 together is (⅓)16 or over 1 in 43 million. Note that if we did not have the fail regions the odds would be (½)Ô16 or just 1 in about 64 thousand.

The purpose of Part 1 is to make the receiver switch out of what we have called channel choosing mode if a real signal comes in and the receiver is reading noise. Part 1 needs to be sufficiently different from Part 3 to ensure that it will cause the pattern of Part 3 to fail, forcing the receiver to switch out of channel choosing mode and start looking for the pattern of Part 2. If Part 1 were not included and the receiver was reading noise in channel choose mode it could miss the incoming real data because it would not be looking for Part 2 until too late.

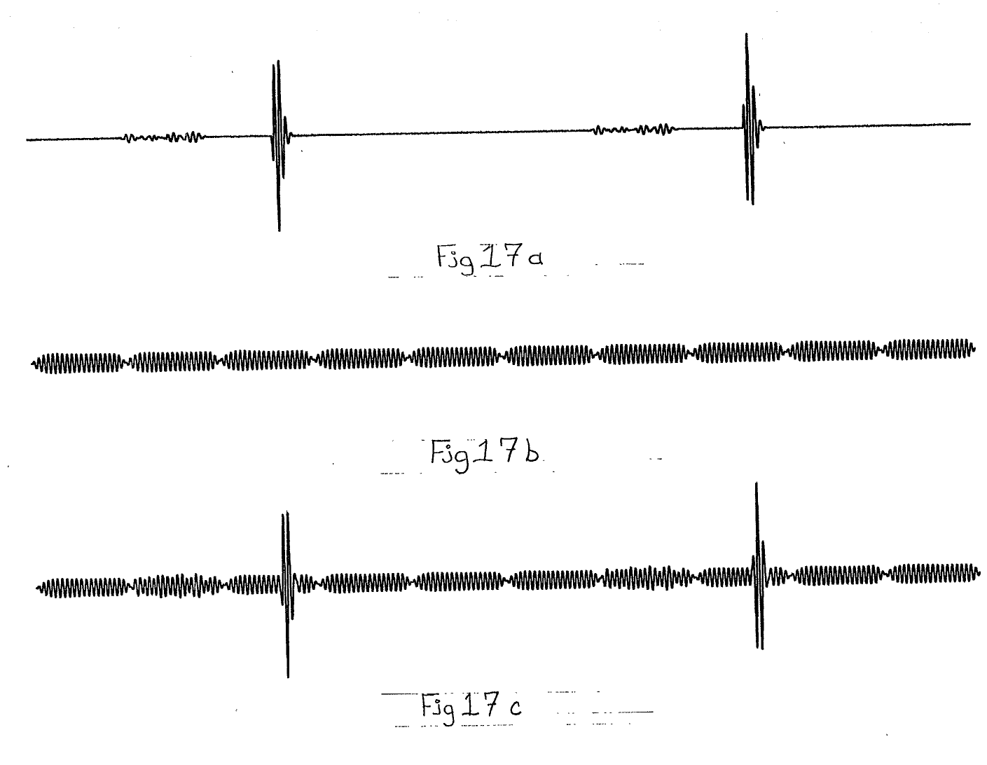

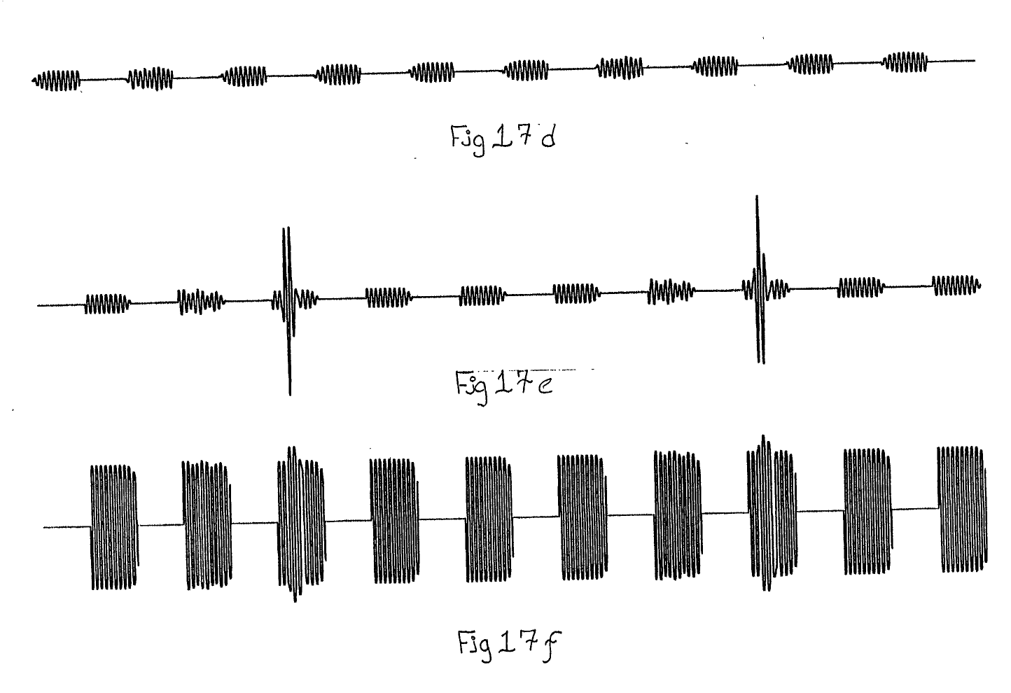

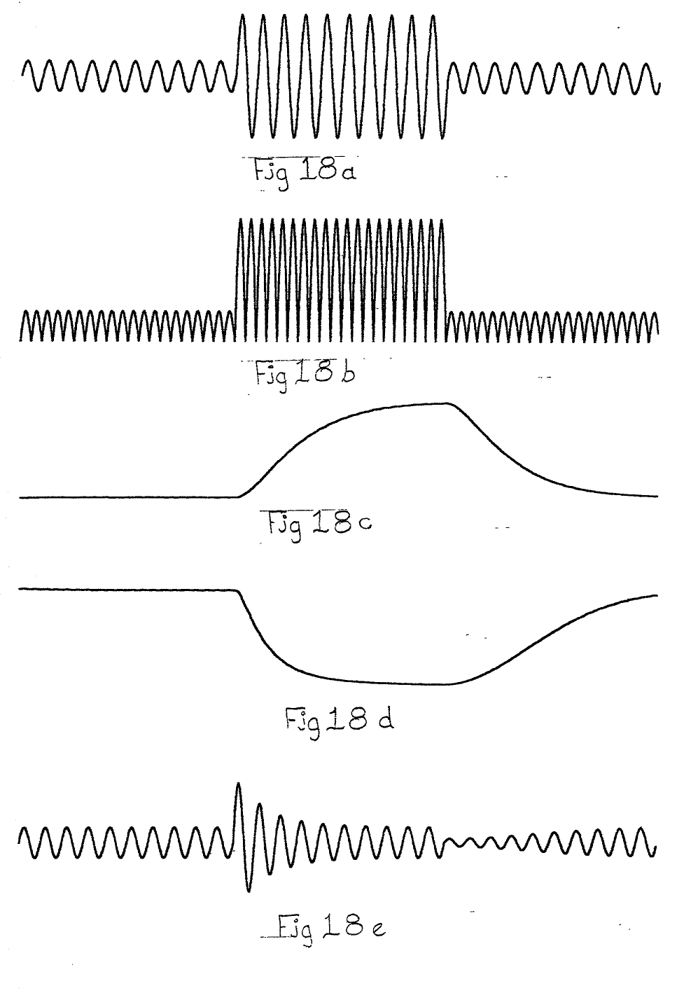

There is another important purpose to Part 3. To discuss this we first need to discuss the nature of noise on the power line. Noise on the power line tends to be repetitive in nature repeating with each half cycle of the 60 Hz (or 50 Hz) AC voltage waveform. This is shown in FIGS. 16a-c. FIG. 16a shows a 60 Hz waveform for 120 Volt AC power. FIG. 16b shows this high-pass filtered so the noise can be seen. As you can see the noise is repetitive. FIG. 16c shows the waveform after bandpass filtering to remove out of band noise. Note in particular the big bursts of noise that were caused by a light dimmer. If Part 3 is long enough and the bit rate of the transmitted signal is an integer multiple of the half wave frequency of the AC waveform these bursts can be easily rejected. This is illustrated in FIGS. 17a-f.

FIG. 17a shows the noise on the power line. FIG. 17b shows Part 3 of the preamble. FIG. 17c shows these combined. It is important to note that an even number of bits span half the AC waveform, in this case 5 bits. This is what was meant by having the bit rate an integer multiple of the half wave frequency of the AC waveform. In this case if we assume that the AC waveform is at 60 Hz the half wave frequency is 120 Hz. Our bit rate is 5 ×120 or 600 bits per second (BPS).

FIG. 17d shows bit channel A. FIG. 17e shows bit channel B. The large bursts of noise caused by the light dimmer fall into bit channel B and cause the pattern received for this bit channel to not be that of Part 3 of the preamble. Therefore bit channel A is chosen during Part 3 of the preamble. Because of the repetitive nature of noise on the power line and the fact that we have our bit rate an integer multiple of the half wave frequency this burst noise falls into bit channel B over and over again, and does not fall into bit channel A. Since bit channel B was rejected the burst noise is ignored and does not affect the reception of the signal. It is important to note that the receiver (or transmitter) does not try and synchronize to the AC voltage waveform nor does it need to.

FIG. 17f will be discussed below.

The problem of attenuation will now be discussed. As mentioned above, there can be a great deal of signal attenuation in an environment like the power line. Units that are close to each other will have little signal attenuation while units far apart could have attenuation of a factor of 10,000 or more. Because of this it is common to have some form of automatic gain control. A typical method is to rectify the incoming signal after filtering and low pass filter it. The size of this filtered signal is used in a feedback loop to increase or decrease the gain to try and maintain it at a reasonable level. The problem with this (besides being complicated) is that the rectified signal is low pass filtered. It therefore lags the signal and the automatic gain control is constantly playing a game of “catch up” with the signal. This is illustrated in FIGS. 18a-e.

FIG. 18a shows the incoming signal. FIG. 18b shows the rectified signal. FIG. 18c shows the low-pass filtered rectified signal. FIG. 18d shows the resulting gain from the feedback loop. FIG. 18e shows the output after the automatic gain control. Note how the gain lags the signal. For large bursts of noise this lag can be very detrimental.

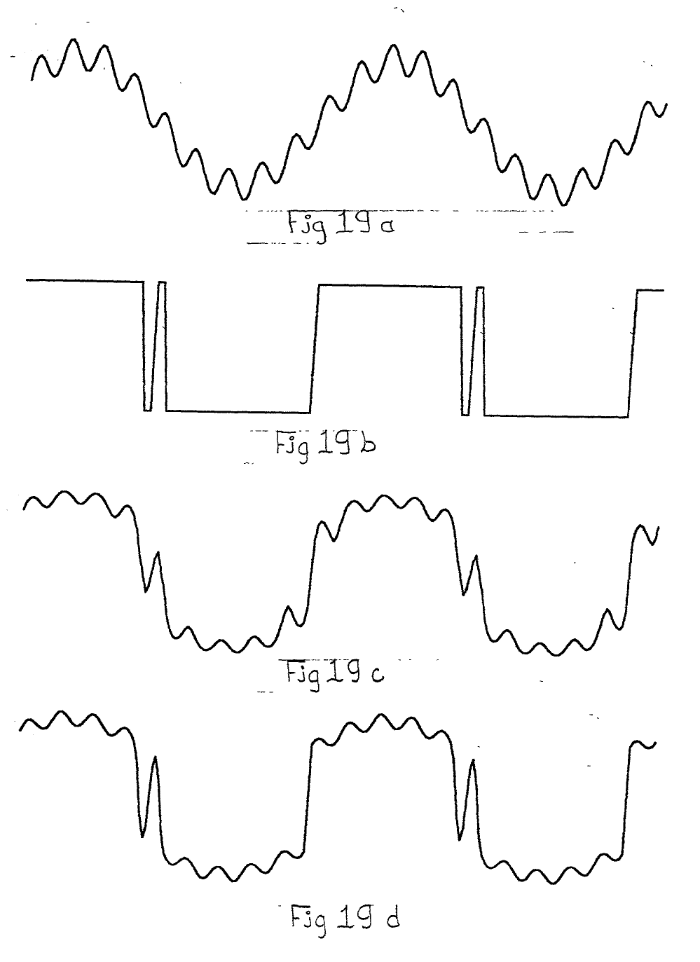

A method that does not have the complication or lag of automatic gain control is to simply use a large gain and clip the signal. However, if out of band noise is not completely filtered by the bandpass filter stage (bandpass filter 31 of FIG. 3) this method can cause the loss of a signal. This is illustrated in FIGS. 19a-b. FIG. 19a is the filtered signal before gain. In this example it is the higher frequency component of the waveform that is the signal, the lower frequency component of the waveform is noise. FIG. 19b is the result of clipping this signal after large gain. As you can see the signal waveform is essentially lost by this method.

Another method is to use non-linear gain, for example logarithmic gain. Using logarithmic gain in the form of Vout=log10(Vin) causes the output of the gain stage to only vary by a factor of 4 for input signals varying by a factor of 10,000. This signal compression aids in receiving signals that can vary a great deal in magnitude. FIG. 19c illustrates this type of non-linear gain. As you can see the signal is much more readily visible as compared to FIG. 19b. Non-linear amplification can therefore help with the problem of attenuation. However, logarithmic amplifiers can be difficult to construct. As well, it might be desired to have an amplification of 1000 or more. For frequencies typically used to communicate on the power line having a gain of 1000 in one stage is difficult and costly. FIG. 19d is described below.

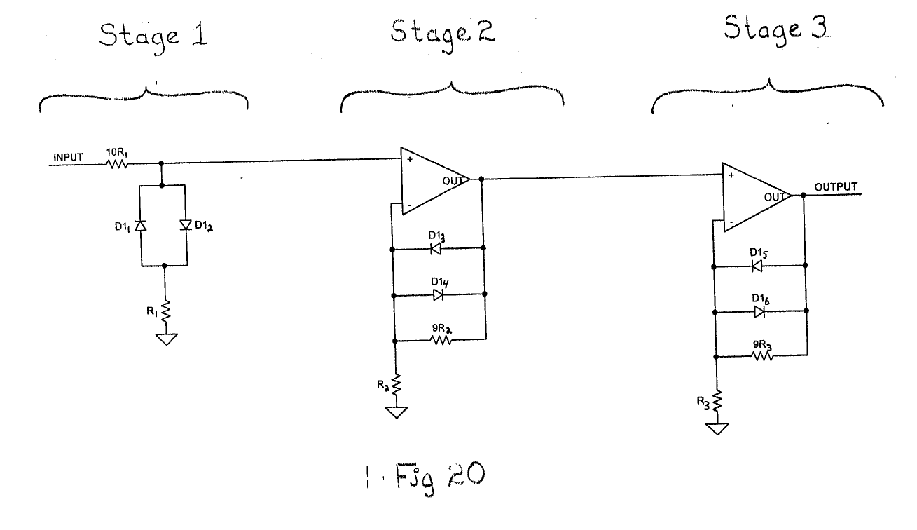

FIG. 20 shows a method of non-linear gain that is simple and inexpensive.

FIG. 19d shows the output of this type of non-linear amplifier. As you can see the higher frequency signal is not lost. Referring to FIG. 3 the optional second filter stage 33 is used to remove overtones that are generated by this non-linear gain stage.

This non-linear gain stage has the added advantage of suppressing large amplitude noise bursts. FIG. 17f shows FIG. 17e after this non-linear gain. As you can see the noise bursts in FIG. 17f are suppressed compared to FIG. 17e.

The above discussion has been limited to one channel of communication. That is we have been discussing a system that uses one carrier frequency. However, more than one carrier could be used to form multiple channels of communication. This could be used to provide faster bit rates and/or to provide a full duplex system. As well, the system could be constructed so that it could change carrier frequency(s) in order to avoid noise.

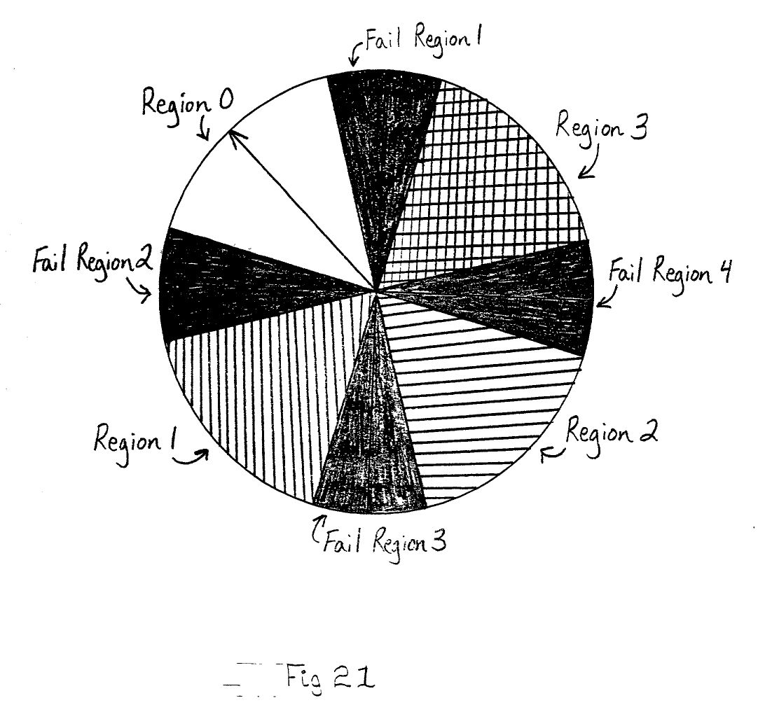

We have concentrated on BPSK. The system could be used for other modulation methods such as Quadrature Phase Shift Keying (QPSK). In QPSK two bits are encoded per symbol and the system looks for 0°, 90°, 180°, or 270° phase changes. This is illustrated in FIG. 21. Note that we now have four regions where we consider the signal to be acceptable (double that of BPSK). Between them they also define four regions where we say the signal has failed.

The system could use both BPSK and QPSK in one message. For example, it could transmit the preamble in BPSK then shift to QPSK.

As well, the system could use QPSK when the communications environment allowed it, and then shift to the more robust BPSK when the communications environment demanded it.

When discussing the bit channels in the above we have assumed that the analog to digital sampling spans the entire demi-bit. This need not be the case. Sampling can occur for only a portion of a demi-bit. For example the system could sample for the first half of a demi-bit then use the remainder of the demi-bit to process these samples.

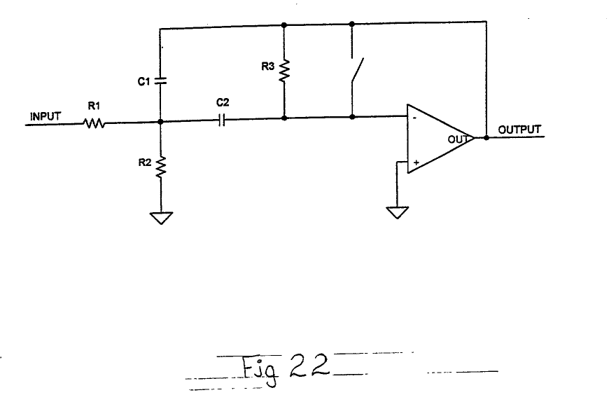

This period when sampling is not taking place can be used to do additional analog signal manipulation. FIG. 22 shows a form of bandpass filter with a switch added. The values of the various components are unimportant for this discussion.

Analog filters tend to ring. That is they have an output that continues after the input is removed. In FIG. 22 if the switch is closed for a brief time it will reset the filter and stop this ringing. This switch closure could be done during the portion of the demi-bit when sampling is not taking place. If we assume that this portion is at the end of the demi-bit, closing the switch for a brief period will ensure that any noise that causes the filter to ring will not affect the next demi-bit.

This switch need not be a mechanical switch.

In the above we stated that if the signal falls into a fail region we say the signal has failed. This need not be the case. We could allow for one or more “failures” to occur before saying the signal has failed.

In the above we have considered the preamble to be made of three distinct parts. This need not be the case. By way of example, Parts 2 and 3 could be combined.

In the above we calculated the phase of our signal by using the average of the x and y channel points. This need not be the case. We could calculate the phase of each pair of channel points then calculate an average of these phases, in effect setting the magnitude of each set of samples to be equal. This has the effect of further signal compression as each set of points is weighted equally. However, the magnitude of the resulting vector will still be larger for the demi-bit centered on the signal bit.

In the above we have discussed the affects of clipping the signal. (Refer to FIGS. 19a-19b.) FIG. 19b shows the result of large gain followed by clipping. This can be considered to be the same as performing an analog to digital conversion with one bit resolution. If the signal is above zero in FIG. 19a we say it has a level of “1” if it is below zero we say it has a level of “0”. As FIG. 19b illustrates, there are disadvantages to this method of using a zero reference. However, the simplicity of the resulting signal has the advantage of making it possible to use one or more digital correlators to perform the x and y channel calculations.

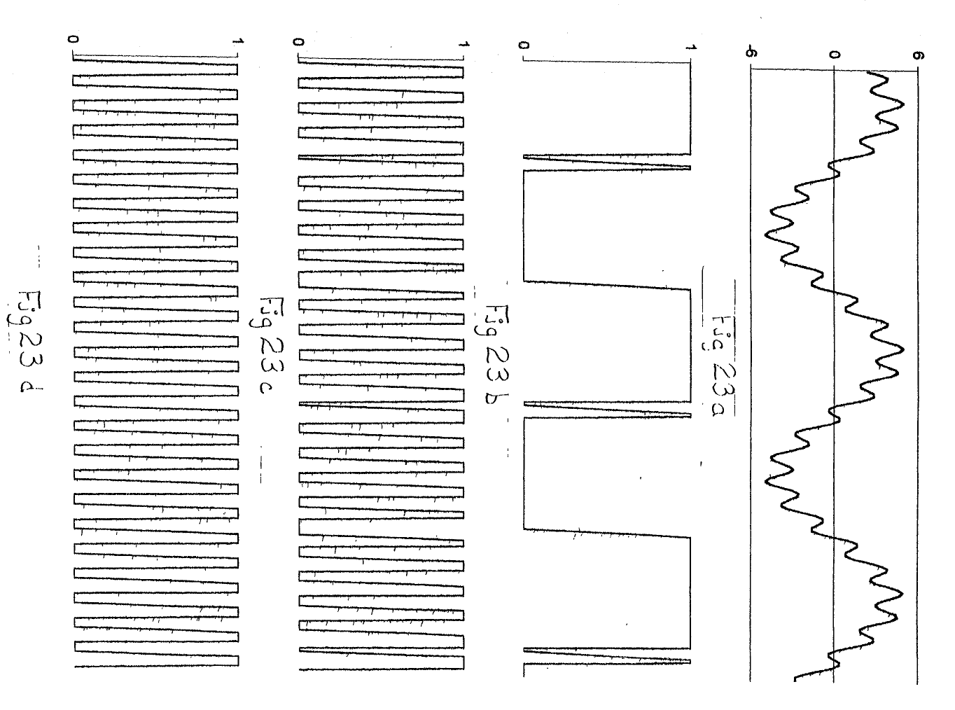

A better method than using a zero reference is illustrated in FIGS. 23a-d. FIG. 23a is a signal similar to FIG. 19a. As before the higher frequency component of this waveform is the signal, the lower frequency component is noise. FIG. 23b shows the result of using a zero reference and saying the signal is “1” if it is above zero and “0” if it is below zero. As you can see the signal is essentially lost. FIG. 23c shows the result that is obtained if there is no zero reference but instead we say the signal is a “1” if it is larger than the last signal sample and a “0” if it is smaller than the last signal sample. FIG. 23d shows the same method applied to a signal that did not contain the lower frequency noise. As you can see the signal is much better represented by this method.

Note that in this case sampling needs to be done at a faster rate than was show in FIGS. 6a-6e in order to obtain sufficient angle resolution from the one bit resolution of our samples. However, the use of digital correlators is not limited to samples that have only one bit of resolution.

As will be apparent to those skilled in the art in the light of the foregoing disclosure, many alterations and modifications are possible in the practice of this invention without departing from the spirit or scope thereof. As claimed herein the phrase wave form is intended to mean any noise source having a repetitive nature including any device interfered with by any repetitive noise on the AC power line, not necessarily communicating on the AC power line. Accordingly, the scope of the invention is to be construed in accordance with the substance defined by the following claims.

What is claimed is:

1. A method of communication in an environment having repetitive noise, said method comprising the steps of:
(a) in a receiver, de-modulating an incoming signal containing signal bits by taking digital samples of the incoming signal so as to demodulate the incoming signal into separate x and y channels, said x and y channels approximating respectively, a co-sine and sine wave,
(b) summing consecutive groups of said samples from said x and y channels so as to determine corresponding x and y channel points, wherein each group of said consecutive groups contains substantially the same number of said samples,
(c) within said receiver, defining at least first and second demi-bits wherein each demi-bit of said first and second demi-bits is of the same length and wherein said first and second demi-bits together, or integer multiples of said first and second demi-bits together, are the same length as one signal bit of said signal bits,
(d) using said x and y channel points within said demi-bits to calculate an average phase and an average magnitude over each said demi-bit:
(i) so as to produce a first bit channel of said y channel points when averaged over said first demi-bits, and a first channel of said x channel points when averaged over said first demi-bits,
(ii) and so as to produce a second bit channel of said y channel points when averaged over said second demi-bits, and a second channel of said x channel points when averaged over said second demi-bits,
(e) determining the resulting phase and magnitudes of said first demi-bits of said first bit channel and the resulting phase and magnitudes of said second demibits of said second bit channel,
(f) comparing the magnitudes of said first and second bit channels and choosing the bit channel having the largest overall magnitude as the bit channel from which data is to be read,
(g) reading data from said bit channel from which data is to be read by determining phase angles in that bit channel, wherein said phase angles indicate corresponding phase-shift keyed data bits as determined by rejecting phase angles which fall into phase-shift angle fail regions interposed between ranges of acceptable phase-shift angles,
and wherein the signal bit rate of the incoming signal is adapted to be an integer multiple of the half-wave frequency of the alternating current wave form, and wherein a signal processor of said receiver does not, when processing the incoming signal, synchronize to and track the alternating current voltage wave form or any part of the incoming signal.

2. The method of claim 1 wherein the communication channel is the AC power line.

3. The method of claim 1 further comprising the steps of defining a third demi-bit, producing a third bit channel, and rejecting two of the three bit channels leaving said bit channel from which date is to be read.

4. The method of claim 3 wherein said first demi-bit is denoted by A(n), A(n+1), A(n+2) . . . , wherein said second demi-bit is denoted by B(n), B(n+1), B(n+2) . . . , and wherein said third demi-bit is denoted by C(n), C(n+1), C(n+2. . . , and wherein said method further comprising the steps of producing said bit channels by overlapping said demi-bits.

5. The method of claim 4 wherein said step of producing said bit channels by overlapping said demi-bits comprises producing said first bit channel of the form A(n)+B(n), A(n+1)+B(n+1), A(n+2)+B(n+2) . . . , said second bit channel of the form B(n)+C(n), B(n+1)+C(n+1), B(n+2)+C(n+2) . . . , and said third bit channel of the form C(n) +A(n+1), C(n+1)+A(n+2), C(n+2)+A(n+3) . . . .

6. The method of claim 1 further comprising the step of detecting and processing a multipart preamble in said incoming signal and, once said particular signal pattern is found, commences to choose a channel, including said step of comparing said magnitudes of said first and second bit channels and choosing the bit channel having the largest overall magnitude as the bit channel from which data is to be read, for processing another part of said multi-part preamble.

7. The method of claim 6 further comprising the step of preventing a transmission from a transmitter corresponding to said receiver while said receiver is choosing a channel.

8. The method of claim 6 wherein said preamble contains yet another part, said method comprising the further step of said receiver monitoring so as to detect said yet another part of said preamble and upon detection of said yet another part of said preamble switching out of said choosing a channel and returning to monitoring so as to detect said one part of said preamble.

9. The method of claim 8 wherein said yet another part of said preamble is a first part of said preamble, said one part of said preamble is a second part of said preamble and said another part of said preamble is a third part of said preamble, and wherein said first, second and third parts of said preamble are consecutive parts of said preamble.

10. The method of claim 9 wherein said third part of said preamble consists substantially of phase changes.

11. The method of claim 9 wherein said second part of said preamble is a random pattern.

12. An apparatus for communicating in an environment having repetitive noise, said apparatus comprising:
(a) in a receiver, a demodulator for de-modulating an incoming signal containing signal bits, said demodulator demodulating the incoming signal by taking digital samples of the incoming signal so as to demodulate the incoming signal into separate x and y channels so that said x and y channels approximate respectively, a co-sine and sine wave,
(b) means for summing consecutive groups of said samples from said x and y channels so as to determine corresponding x and y channel points, wherein each group of said consecutive groups contains substantially the same number of said samples,
(c) means within said receiver for defining at least first and second demi-bits wherein each demi-bit of said first and second demi-bits is of the same length and wherein said first and second demi-bits together, or integer multiples of said first and second demi-bits together, are the same length as one signal bit of said signal bits,
(d) means for using said x and y channel points within said demi-bits to calculate an average phase and an average magnitude over each said demi-bit:
(i) so as to produce a first bit channel of said y channel points when averaged over said first demi-bits, and a first channel of said x channel points when averaged over said first demi-bits,
(ii) and so as to produce a second bit channel of said y channel points when averaged over said second demi-bits, and a second channel of said x channel points when averaged over said second demi-bits,
(e) means for determining the resulting phase and magnitudes of said first demi-bits of said first bit channel and the resulting phase and magnitudes of said second demi-bits of said second bit channel,
(f) means for comparing the magnitudes of said first and second bit channels and choosing the bit channel having the largest overall magnitude as the bit channel from which data is to be read,
(g) means for reading data from said bit channel from which data is to be read by determining phase angles in that bit channel, wherein said phase angles indicate corresponding phase-shift keyed data bits as determined by rejecting phase angles which fall into phase-shift angle fail regions interposed between ranges of acceptable phase-shift angles,
and wherein the signal bit rate of the incoming signal is adapted to be an integer multiple of the half-wave frequency of the alternating current wave form, and wherein a signal processor of said receiver does not, when processing the incoming signal, synchronize to and track the alternating current voltage wave form or any part of the incoming signal.

13. The apparatus of claim 12 further comprising means for defining a third demi-bit, producing a third bit channel, and rejecting two of the three bit channels leaving said bit channel from which date is to be read.

14. The apparatus of claim 13 wherein said first demi-bit is denoted by A(n), A(n+1), A(n+2) . . . , wherein said second demi-bit is denoted by B(n), B(n+1), B(n+2) . . . , and wherein said third demi-bit is denoted by C(n), C(n+1), C(n+2) . . . , and wherein said apparatus further comprises means for producing said bit channels by overlapping said demi-bits.

15. The apparatus of claim 14 wherein said means for producing said bit channels by overlapping said demi-bits includes means for producing said first bit channel of the form A(n)+B(n), A(n+1)+B(n+1), A(n+2)+B(n+2) . . . , said second bit channel of the form B(n)+C(n), B(n+1)+C(n+1), B(n+2)+C(n+2) . . . , and said third bit channel of the form C(n)+A(n+1), C(n+1)+A(n+2), C(n+2)+A(n+3) . . . .

16. The apparatus of claim 12 further comprising means for detecting and processing a multi-part preamble in said incoming signal and, once said particular signal pattern is found, commencing to choose a channel, for processing another part of the multi-part preamble.

17. The apparatus of claim 16 further comprising means for preventing a transmission from a transmitter corresponding to said receiver while said receiver is choosing a channel.

18. The apparatus of claim 16 wherein, when said preamble contains yet another part, said apparatus comprising means for monitoring so as to detect said yet another part of said preamble and upon detection of said yet another part of said preamble switching out of said choosing a channel and returning to monitoring so as to detect said one part of said preamble.
